(19) United States
(12) Patent Application Publication
(10) Pub. No.: US 2010/0258668 A1
(43) Pub. Date: Oct. 14, 2010

(54) BELT RETRACTOR WITH TIGHTENER DRIVER

(76) Inventor: Christoph Pechhold, Erbach (DE)

Correspondence Address: FOLEY AND LARDNER LLP;SUITE 500, 3000 K STREET NW, WASHINGTON, DC, 20007, US

(21) Appl. No.: 12/735,125

(22) PCT Filed: Dec. 16, 2008
(86) PCT No.: PCT/DE2008/002100

§ 371 Date: Jun. 17, 2010

(30) Foreign Application Priority Data
Dec. 20, 2007 (DE) 10 2007 063 461.9

(51) Int. Cl. B60R 22/46; B65H 75/44

(52) U.S. Cl. 242/374

(57) ABSTRACT

The invention relates to a belt retractor (10) for a safety belt (30) with a belt reel (20) for winding and unwinding the safety belt and with a tightener drive, which comprises: a gas generator (60), a drive device (40) connected to the belt reel (20), and a connecting device (50), which connects the gas generator and the drive device, the connecting device having a guide tube (70) and a plurality of thrust members (80), which are situated in the guide tube, are accelerated after triggering of the gas generator and directly or indirectly drive the drive device for the purpose of winding the safety belt.

According to the invention, at least one sealing element (100a, 100b, 100c) is arranged in the guide tube (70) between the gas generator (60) and that side (80a′) of at least one of the thrust bodies (80a, 80b, 80c) which faces the gas generator, which sealing element rests against the inside of the guide tube.

The invention relates to a belt retractor for a safety belt with a belt reel for winding and unwinding the safety belt and with a tightener drive, in accordance with the preamble of claim 1.

A belt retractor of this kind with a tightener drive is known from European Patent Application EP 1 283 137. The tightener drive comprises a gas generator, a drive device connected to the belt reel of the belt retractor, and a connecting device, which connects the gas generator and the drive device. The connecting device has a guide tube and a multiplicity of thrust members, which are situated in the guide tube, are accelerated after triggering of the gas generator and drive the drive device for the purpose of winding the safety belt.

Starting from the prior art described, the object on which the invention is based is to provide a belt retractor which has good tightening power while requiring as little, space as possible.

According to the invention, this object is achieved on the basis of a belt retractor of the type described at the outset by means of the characterizing features of claim 1. Advantageous embodiments of the belt retractor according to the invention are specified in subclaims.

According to the invention, these make provision for at least one sealing element to be arranged in the guide tube between the gas generator and that side of at least one of the thrust bodies which faces the gas generator, which sealing element rests against the inside of the guide tube, preferably in a gastight manner.

One significant advantage of the belt retractor according to the invention is to be regarded as the fact that a loss of gas and therefore pressure through the gap between the thrust members and the guide tube is prevented by the sealing element provided in accordance with the invention. Although the outside diameter of the thrust members in the prior art belt retractors is usually matched to the inside tube diameter of the guide tube, a certain residual gap must always be allowed for in order to prevent the mechanical friction losses of the thrust members due to friction against the inner wall of the guide tube becoming too large. It is at this point that the invention comes in, proposing to perform additional sealing by means of at least one sealing element, thereby avoiding pressure loss, or at least reducing it, and increasing the power of the tightener.

The sealing element is preferably narrower than the thrust bodies. The term “narrower” is to be understood to mean that the longitudinal extent of the sealing element in the longitudinal direction of the guide tube is less than the longitudinal extent of the thrust bodies in the longitudinal direction of the guide tube. One advantage of this embodiment is that the size of the tightener drive is increased to only a minimal or insignificant extent by one or more sealing elements—as seen in the longitudinal direction of the guide tube—in contrast, for example, to other, “thick”, sealing elements, such as sealing balls or the like.

It is particularly preferred that the sealing element has a radially outer outward region and a radially inner inward region, the inward region being narrower than the outward region. In this embodiment, a good sealing effect is achieved by means of the thick outward region without a significant increase in the size of the tightener drive as a result; since the spacing between the mass elements can remain relatively small because the mass elements can rest against the narrow inward region of the sealing element. Moreover, sealing elements that are narrow on the inside and thicker on the outside have a lower mass than sealing elements of a different shape, such as sealing balls. Owing to their lower mass, sealing elements that are narrow on the inside and thicker on the outside furthermore “consume” less tightener power than other sealing elements when they are accelerated together with the thrust members.

With a view to a particularly good sealing effect, it is regarded as advantageous if the sealing element has in its radially outer outward region a sealing lip which tapers radially toward the outside. It is particularly preferred if the sealing element has in its radially outer outward region at least two sealing lips, which are separated from one another by a groove.

According to a particularly preferred embodiment, the sealing element is formed by a sealing ring, the outer ring side of which rests against the inside of the guide tube. One advantage of this variant is in the good sealing effect for a minimum additional mass since the inward region of the sealing element remains free.

In a particularly preferred embodiment of the belt retractor, the sealing ring is shaped in such a way that two adjacent thrust members separated by the sealing ring do not normally touch one another, i.e. neither before triggering of the gas generator nor after triggering of the gas generator, during “trouble-free tightener operation”. Here, “trouble-free tightener operation” is to be understood to mean that, to tighten the safety belt, the thrust members are accelerated in the direction of the drive device by the gas emerging from the gas generator, driving the belt reel in the process. It is at most only in the case where the belt reel and/or the drive device are impeded and the thrust members cannot, as a result, be moved through the guide tube—that is to say where the tightening process is disrupted—that the sealing rings should allow adjacent thrust members to come into contact.

An appropriate separating effect of the sealing rings is achieved, for example, if the ratio between the outside diameter and the inside diameter of the sealing rings is between 1.5 and 3. This ratio furthermore allows very effective acceleration of the thrust members.

With a view to good sealing of the guide tube, it is regarded as advantageous if the outside diameter of the sealing element is between 1.02 and 1.06 times the inside diameter of the guide tube. In this case, the sealing element must be introduced into the guide tube with radially inward compression.

The sealing element is preferably composed of a flexible material, such as an elastomer. For example, the sealing element is composed of one or more of the following materials or at least also preferably contains it/them: ethylene propylene diene rubber, ethylene propylene rubber, nitrile rubber, hydrogenated nitrile rubber, natural rubber.

The outer side of the sealing element is coated, for example, preferably with a coating which reduces friction on the inner wall of the guide tube. Such a coating can contain one or more fluorinated polymers, for example, e.g. polytetrafluoroethylene (PTFE).

The guide tube and/or the sealing elements/sealing rings can have any desired inner contour or outer contour, e.g. a round, oval or polygonal, in particular rectangular or square, contour. The same applies to the inner contour of the ring opening of the sealing rings.

It is furthermore regarded as advantageous if a sealing element is arranged in the guide tube on that side of the first thrust body from the gas generator which faces the gas generator.

It is also possible for a sealing element to be arranged in the guide tube between the first and the second thrust body and/or between the second and the third thrust body from the gas generator, for example.

There are preferably at least two sealing elements in the guide tube, namely, for example, at least one sealing element between the first and the second thrust body from the gas generator and at least one sealing element between the second and the third thrust body from the gas generator.

It is also possible for there to be three sealing elements in the guide tube, namely, for example, at least one sealing element between the first and the second thrust body from the gas generator, at least one sealing element between the second and the third thrust body from the gas generator, and at least one sealing element on that side of the first thrust body from the gas generator which faces the gas generator.

There can, for example, be a drive piston between the gas generator and the first thrust body from the gas generator, but this is not absolutely necessary. If there is a drive piston, there is preferably at least one sealing element between the first thrust body and said drive piston.

The invention is explained in greater detail below with reference to exemplary embodiments; by way of example,

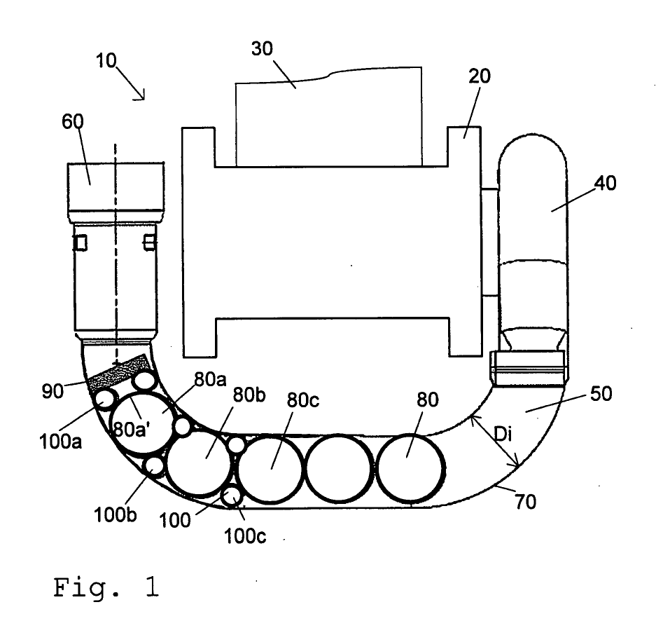

FIG. 1 shows a first exemplary embodiment of a belt retractor according to the invention, in which there are three sealing rings in a guide tube of the belt retractor,

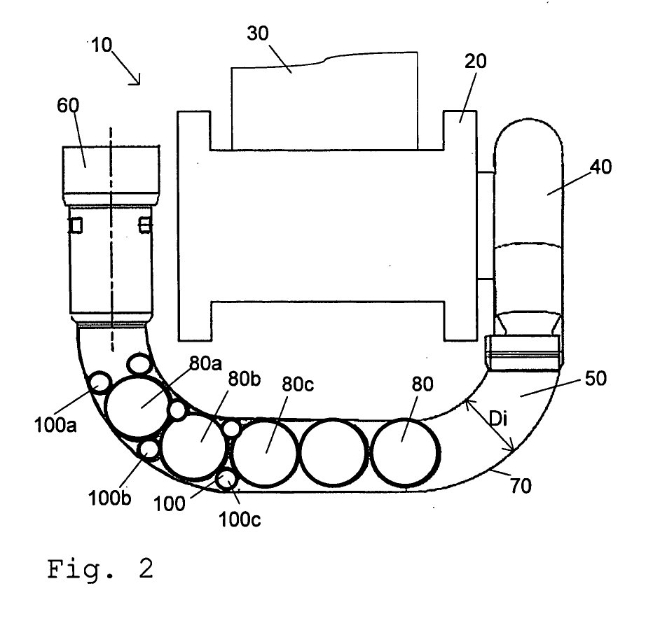

FIG. 2 shows a second exemplary embodiment of a belt retractor according to the invention, in which there is no drive piston between the gas generator and the thrust members,

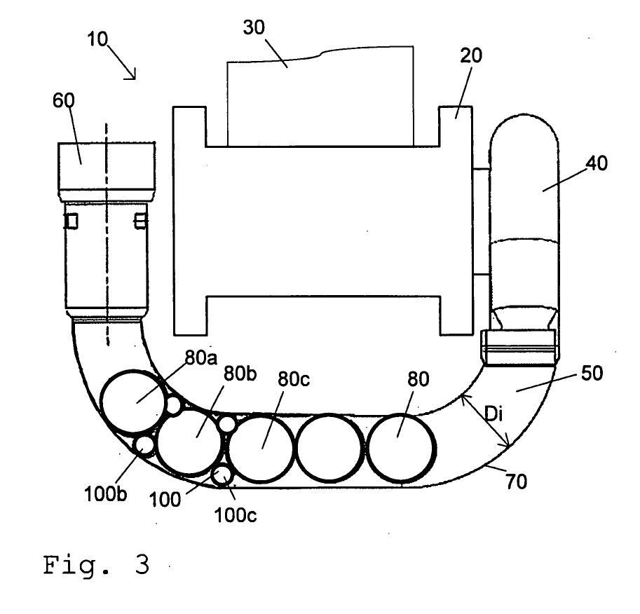

FIG. 3 shows a third exemplary embodiment of a belt retractor according to the invention, having two sealing rings and no drive piston,

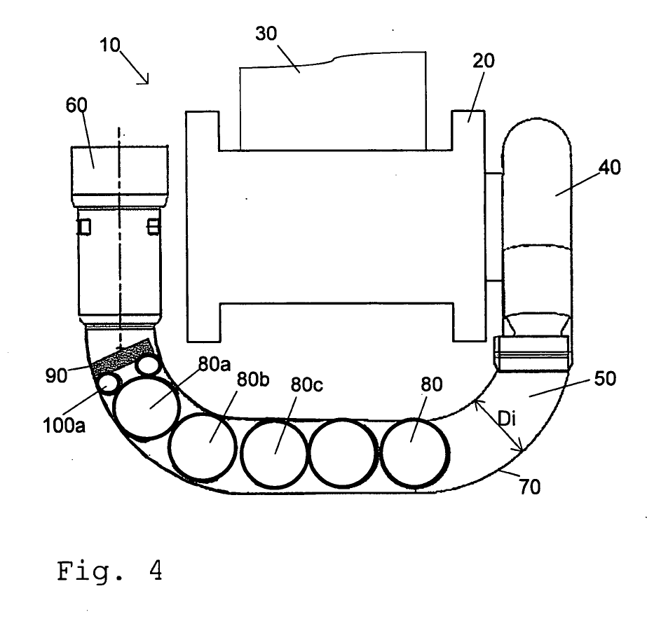

FIG. 4 shows a fourth exemplary embodiment of a belt retractor according to the invention, in which there is only a single sealing ring,

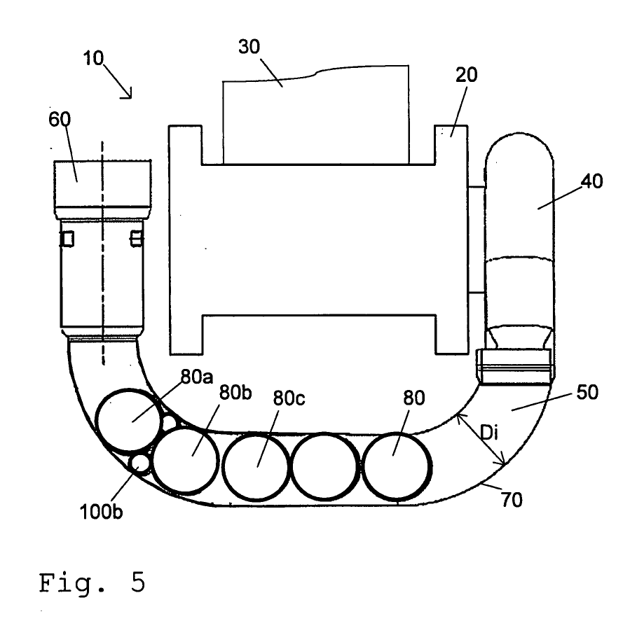

FIG. 5 shows a fifth exemplary embodiment of a belt retractor according to the invention, in which there is likewise only a single sealing ring,

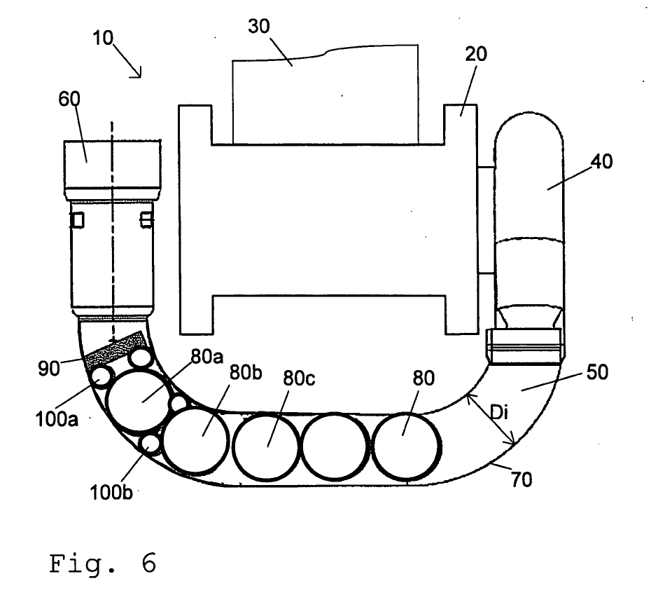

FIG. 6 shows a sixth exemplary embodiment of a belt retractor according to the invention, having two sealing rings and a drive piston,

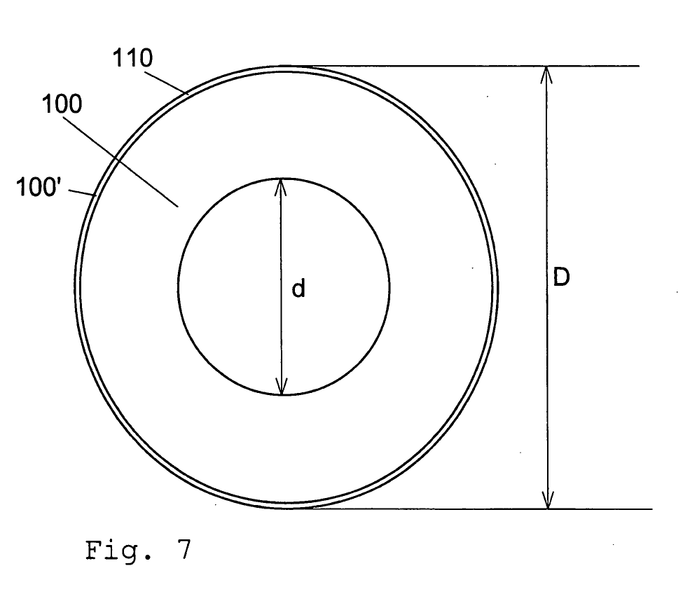

FIG. 7 shows an exemplary embodiment of a sealing ring for the belt retractors shown in FIGS. 1 to 6

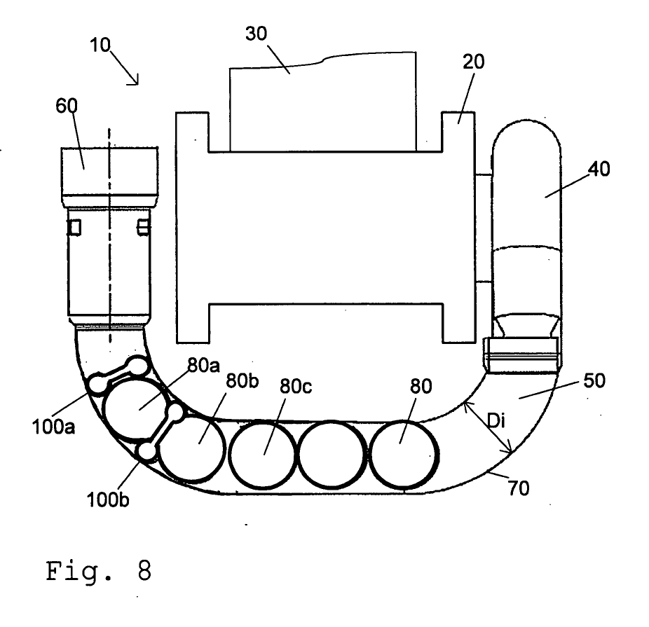

FIGS. 8-10 show a seventh exemplary embodiment of a belt retractor according to the invention, having two sealing elements and no drive piston, and

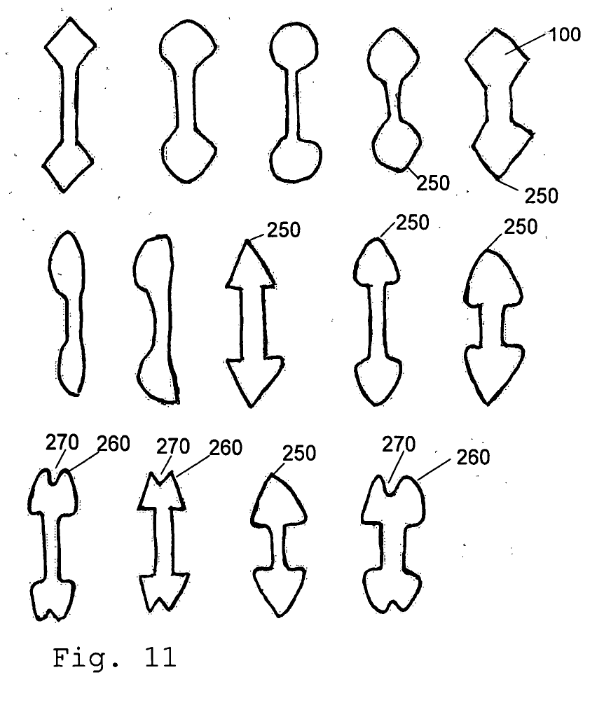

FIG. 11 shows various exemplary embodiments of sealing elements.

In all cases, for the sake of clarity, the same reference numbers are used in the figures for identical or comparable components.

In a simplified schematic representation, FIG. 1 shows components of a belt retractor 10, which is fitted with a tightener drive and comprises a belt reel 20 for winding and unwinding a safety belt 30. The belt retractor 10 furthermore has a drive device 40, which is connected to the belt reel 20 and, via a connecting device 50, to a gas generator 60.

It can furthermore be seen from FIG. 1 that the connecting device 50 has a guide tube 70 with thrust members 80 in the form of balls. The first ball from the gas generator 60 is indicated by the reference number 80a, the second ball by the reference number 80b and the third ball by the reference number 80c. Between the gas generator 60 and the first ball 80a there is a drive piston 90.

Three sealing rings in the form of O rings can furthermore be seen, these being used for the purpose of sealing the guide tube 70. One of these O rings is situated between the drive piston 90 and the first ball 80a, more particularly on that side 80a′ of the ball 80a which faces the gas generator 60.

There is a further O ring 100b between the first ball 80a and the second ball 80b, and a third O ring 100c is arranged between the second ball 80b and the third ball 80c.

The function of the O rings 100 is to achieve gas tight sealing of the guide tube 70. For this reason, the outside diameter D of the O rings 100 (cf FIG. 7) is always somewhat larger than the inside diameter Di of the guide tube 70. The outside diameter D of the O rings 100 is about 2% to 6% larger than the inside diameter Di of the guide tube 70. The following equation then applies, for example:

Di*1.02≦D≦Di*1.06

A cross section of the O rings 100 is shown by way of example in FIG. 7. In the case of the O rings 100, the sealing effect mentioned above can be achieved, for example, if said rings are composed of one or more of the following materials or contain it/them: ethylene propylene diene rubber, ethylene propylene rubber, nitrile rubber, hydrogenated nitrile rubber, natural rubber.

With respect to the inside diameter d of the O rings 100, it should be mentioned that this should preferably be chosen such that two adjacent balls separated by an O ring do not normally touch one another, i.e. neither before triggering of the gas generator 60 nor after triggering of the gas generator 60, during “trouble-free tightener operation”. Here, “trouble-free tightener operation” is to be understood to mean that, to tighten the safety belt, the balls 80 are accelerated in the direction of the drive device 40 by the gas emerging from the gas generator 60, driving the belt reel 20 in the process. Only in the case where the belt reel 20 and/or the drive device 40 are impeded and the balls 80 therefore cannot be accelerated through the guide tube 70 as intended, despite the triggering of the gas generator 60 that is to say where the tightening process is disrupted—should the O or sealing rings 100 allow the adjacent drive balls 80 to come into contact. An appropriate separating effect of the sealing rings 100 is achieved, for example, if the ratio between the outside diameter D and the inside diameter d of the sealing rings is between 1.5 and 3.

In a particularly preferred embodiment, the O rings 100 are coated on the outside in order to achieve the minimum sliding friction between the O rings 100 and the guide tube 70. A coating of this kind is shown by way of example in FIG. 7, being indicated by the reference number 110. The coating 110 can be composed of polytetrafluoroethylene, for example.

If the vehicle is involved in an accident or there is a critical driving maneuver or an emergency braking situation and, as a result, triggering of the gas generator 60, the gas of the gas generator 60 produces an overpressure which accelerates the drive piston 90 in the direction of the drive device 40. Owing to this acceleration of the drive piston 90, the balls 80 are likewise accelerated in the direction of the drive device 40, with the result that the drive device 40 is driven and can in turn drive the belt reel 20 so as to wind the safety belt 30. A pressure loss owing to gas unintentionally passing between the balls 80 and the guide tube 70 and through to the drive device 40 is avoided by means of the O rings 100 since they bring about sealing at the outside. The O rings 100 are furthermore accelerated together with the balls 80.

Regarding the construction of the gas generator 60, the guide tube 70, the drive device 40 and the belt reel 20, reference may be made, for example, to publication EP 1 283 137 A2, already mentioned at the outset, in which a corresponding belt retractor is shown by way of example. The belt retractor 10 shown in FIG. 1 can be constructed in a similar manner or, of course, differently.

A second exemplary embodiment of a belt retractor 10 is shown in FIG. 2. In contrast to the first exemplary embodiment shown in FIG. 1, there is no drive piston 90, and the gas of the gas generator 60 can therefore act directly on the first O ring 100a and on the first ball 80a. In other respects, the second exemplary embodiment corresponds to the first exemplary embodiment shown in FIG. 1.

A third exemplary embodiment of a belt retractor 10 is shown in FIG. 3. In this belt retractor, there are two sealing rings 100b and 100c in the guide tube 70. In this case, one of the two O rings 100b is situated between the first ball 80a and the second ball 80b, and the second O ring 100c is situated between the second ball 80b and the third ball 80c. In this third exemplary embodiment, there is likewise no drive piston like that in the first exemplary embodiment shown in FIG. 1.

A fourth exemplary embodiment of a belt retractor 10 is shown in FIG. 4. In this fourth exemplary embodiment, there is only a single O ring 100a, which is situated between the drive piston 90 and the first ball 80a of the connecting device 50. In other respects, the fourth exemplary embodiment corresponds to the first exemplary embodiment shown in FIG. 1.

A fifth exemplary embodiment of a belt retractor is shown in FIG. 5. In this fifth exemplary embodiment, there is likewise a single sealing ring 100b, and this single sealing ring 100b is arranged between the first ball 80a and the second ball 80b. There is no drive piston 90. In other respects, the fifth exemplary embodiment corresponds to the first exemplary embodiment shown in FIG. 1.

A sixth exemplary embodiment of a belt retractor is shown in FIG. 6. In this sixth exemplary embodiment, there are two O rings 100a and 100b in the guide tube 70. The first O ring 100a is situated between the drive piston 90 and the first ball 80a, and the second O ring 100b is situated between the first ball 80a and the second ball 80b.

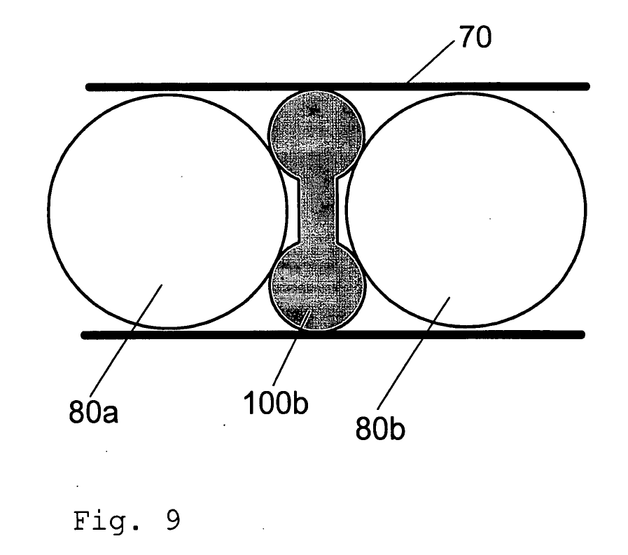

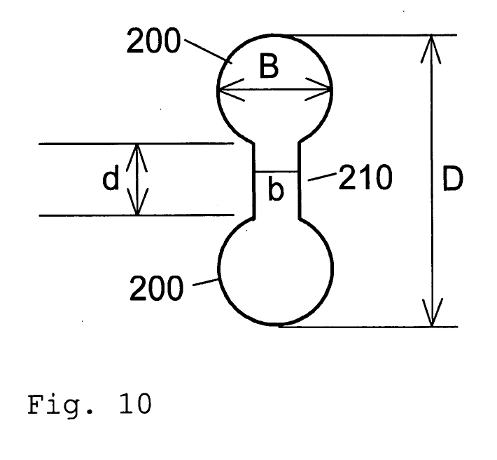

An exemplary embodiment with two sealing elements 100a and 100b, without a drive piston, is shown in FIG. 8. The sealing element 100b with the two balls 80a and 80b are shown again in detail in FIG. 9. The sealing element 100a/100b is shown again on its own in FIG. 10, by way of example.

In FIGS. 8 and 9, it can be seen that the sealing elements are narrower than the balls.

FIG. 10 illustrates the fact that the sealing element 100 has a radially outer outward region 200 and a radially inner inward region 210, the inward region 210 being narrower than the outward region 200. The thickness in the inward region 210 is indicated by the reference number b, and the thickness in the outward region 200 is indicated by the reference number B. The following therefore applies: b<B.

The inside diameter d and the outside diameter D can lie within the following ranges, for example:

3 mm≦d≦6 mm

11 mm≦D≦11.6 mm

FIG. 11 shows further exemplary embodiments of sealing elements 100. Some of these exemplary embodiments have a sealing lip 250 which tapers radially toward the outside. Others have a sealing lip pair 260, each with two sealing lips separated from one another by a groove 270.

### LIST OF REFERENCE NUMBERS

10 Belt retractor
20 Belt reel
30 Safety belt
40 Drive device
50 Connecting device
60 Gas generator
70 Guide tube
80 Thrust members
80a Ball
80a′ Side
80b Ball
80c Ball
90 Drive piston
100 O ring
100a O ring
100b O ring
100c O ring
100′ Outer ring side
110 Coating
200 Outward region
210 Inward region
250 Sealing lip
260 Sealing lip pair
270 Groove
D Outside diameter
Di Inside diameter
d Inside diameter
b, B Thicknesses

1. A belt retractor (10) for a safety belt (30) with a belt reel (20) for winding and unwinding the safety belt and with a tightener drive, which comprises:
a gas generator (60),
a drive device (40) connected to the belt reel (20), and
a connecting device (50), which connects the gas generator and the drive device,
the connecting device having a guide tube (70) and a plurality of thrust members (80), which are situated in the guide tube, are accelerated after triggering of the gas generator and directly or indirectly drive the drive device for the purpose of winding the safety belt,
wherein
at least one sealing element (100a, 100b, 100c) is arranged in the guide tube (70) between the gas generator (60) and that side (80a′) of at least one of the thrust bodies (80a, 80b, 80c) which faces the gas generator, which sealing element rests against the inside of the guide tube.

2. The belt retractor as claimed in claim 1,
wherein
the sealing element is narrower than the thrust bodies.

3. The belt retractor as claimed in claim 1,
wherein
the sealing element has a radially outer outward region (200) and a radially inner inward region (210), the inward region being narrower than the outward region.

4. The belt retractor as claimed in claim 3,
wherein the sealing element has in its radially outer outward region a sealing lip (250) which tapers radially toward the outside.

5. The belt retractor as claimed in claim 3,
wherein the at least one sealing element has in its radially outer outward region at least two sealing lips, which are separated from one another by a groove (270).

6. The belt retractor as claimed in claim 1,
wherein the at least one sealing element is formed by a sealing ring (100a, 100b, 100c), the outer ring side (100′) of which rests against the inside of the guide tube.

7. The belt retractor as claimed in claim 6,
wherein the ratio between the outside diameter (D) of the sealing ring and the inside diameter (d) of the sealing ring is between 1.5 and 3.

8. The belt retractor as claimed in claim 1, wherein the outer side (100′) of the at least one sealing element (100) has a friction-reducing coating (110).

9. The belt retractor as claimed in claim 1,
wherein the outside diameter (D) of the sealing element is between 1.02 and 1.06 times the inside diameter (Di) of the guide tube.

10. The belt retractor as claimed in claim 1,
wherein the sealing element is composed of one or more of the following materials or contains it/them: ethylene propylene diene rubber, ethylene propylene rubber, nitrile rubber, hydrogenated nitrile rubber, natural rubber.

11. The belt retractor as claimed in claim 1,
wherein a sealing element (100a) is arranged in the guide tube (70) on that side (80a′) of the first thrust body (80a) from the gas generator which faces the gas generator.

12. The belt retractor as claimed in claim 1,
wherein a sealing element (100b) is arranged in the guide tube (70) between the first and the second thrust body (80a, 80b) from the gas generator.

13. The belt retractor as claimed in claim 1,
wherein a sealing element (100c) is arranged in the guide tube (70) between the second and the third thrust body (80b, 80c) from the gas generator.

14. The belt retractor as claimed in claim 1,
wherein there are at least two sealing elements (100b, 100c) in the guide tube (70), namely at least one sealing element (100b) between the first and the second thrust body (80a, 80b) from the gas generator and at least one sealing element (100c) between the second and the third thrust body (80b, 80c) from the gas generator.

15. The belt retractor as claimed in claim 1,
wherein there are at least three sealing elements (100a, 100b, 100c) in the guide tube, namely at least one sealing element (100b) between the first and the second thrust body (80a, 80b) from the gas generator, at least one sealing element (100c) between the second and the third thrust body (80b, 80c) from the gas generator, and at least one sealing element (100a) on that side (80a′) of the first thrust body (80a) from the gas generator which faces the gas generator.

16. The belt retractor as claimed in claim 1,
wherein there is a drive piston (90) between the gas generator and the first thrust body (80a) from the gas generator.

17. The belt retractor as claimed in claim 1,
wherein the guide tube (70) and/or the inner ring is/are round, oval or polygonal, in particular rectangular or square, in cross section.
